(19) United States
(12) Patent Application Publication
(10) Pub. No.: US 2019/0084546 A1
(43) Pub. Date: Mar. 21, 2019

(54) SPRING CLUTCH OR BRAKE

(71) Applicant: JIAXING LUPAI BRAKE CO., LTD., JIAXING (CN)

(72) Inventor: JIAN LU, JIAXING (CN)

(73) Assignee: JIAXING LUPAI BRAKE CO., LTD.

(21) Appl. No.: 15/897,497

(22) Filed: Feb. 15, 2018

(30) Foreign Application Priority Data
Sep. 19, 2017 (CN) 201721206558.0

(51) Int. Cl. B60T 17/08; A01D 34/68; F16D 13/44; F16D 67/02

(52) U.S. Cl. CPC B60T 17/083; A01D 34/6812; F16D 2013/706; F16D 67/02; F16D 13/44

(57) ABSTRACT

The present invention discloses a spring clutch comprising a coil assembly, a rotor assembly and a pulley assembly. The coil assembly comprises a coil housing, an encapsulated coil and a shell, the encapsulated coil is in the coil housing. The rotor assembly comprises a shaft, a rotor and a sleeve, the sleeve is on the shaft, the shaft is in the rotor, the shaft is in the coil housing. The pulley assembly comprises an armature, leaf springs, a brake plate and a pulley, one side of the leaf spring is pressed with armature and the another side is pressed with pulley, the brake plate is outside of the armature and covered some area of the armature, the pulley is on the sleeve. The brake plate has magnet pieces inside. A spring clutch in accordance with the present invention the brake plate has magnet pieces inside to make the armature has magnetic force to catch up with the brake plate to enable the clutch has strong friction force to reduce the stop time.

### FIELD OF THE INVENTION

The present invention relates to weeder brake field, and more particularly, to a spring clutch or brake for use in a riding lawn mower.

### BACKGROUND OF THE INVENTION

Clutches or brakes are devices used to make lawn mowers drive mowing cutters. Presently, the clutches used in riding lawnmowers lack in technology. The braking speed is slow and has poor stability. In the case of abnormal use or failure, the brakes are likely to overheat and cause spontaneous combustion. There are potential safety problems.

### SUMMARY OF THE INVENTION

The present invention provides a spring clutch or brake.

An object of the present invention is to solve the backward technology of the clutches in the current market, wherein the braking speed is slow and has poor stability. In the case of abnormal use or failure, the brakes are likely to overheat and cause spontaneous combustion. There are potential safety problems.

The technical solution of the present invention to solve the technical problems is as follows: a spring clutch or brake comprises a coil assembly, a rotor assembly, and a pulley assembly. The coil assembly comprises a coil housing, a plastic encapsulated coil and a shell, the encapsulated coil is in the coil housing. The rotor assembly comprises a shaft, a rotor and a sleeve, the sleeve is in the shaft, the shaft is in the rotor, the shaft is in the coil housing. The pulley assembly comprises an armature, leaf springs, a brake plate and a pulley, one side of the leaf spring is pressed on armature and the another side pressed on pulley, the brake plate is outside the armature and covers and overlaps with some area of the armature. The pulley is on the sleeve. In accordance with the present invention, the brake plate has magnet pieces inside and on the brake plate.

Preferably, the encapsulated coil has thermal fuse inside, the thermal fuse is electrical connected with coil wires.

Preferably, the side of the rotor facing armature has a friction ring.

Preferably, the shaft has a front part and a back part, the pulley and sleeve are both in front part, the coil is in back part.

Preferably, the shell has outside pieces, the brake plate has extended pieces, and with bolts and springs, the bolts through outside pieces, springs and extended pieces then fix the brake plate on the shell.

The present invention has the effect of greatly reducing the clutch stop time by more friction. The clutch has brake plate with magnet pieces inside to make the armature catch up with brake plate strongly by the magnetic force from the magnet pieces. The present invention also great to protect lawnmower parts or avoid fire accident that the clutch has encapsulated coil with thermal fuse inside to cut off electricity when encapsulated coil has higher temperature than the thermal fuse during working if clutch fitting incorrect or slipping happened. The present invention has a rotor with friction ring inside the surface facing armature to offer strong initial torque to make the pulley start running well.

### BRIEF DESCRIPTION OF THE DRAWINGS

FIG. 1 is an explosive view of a spring clutch accordance with the present invention.

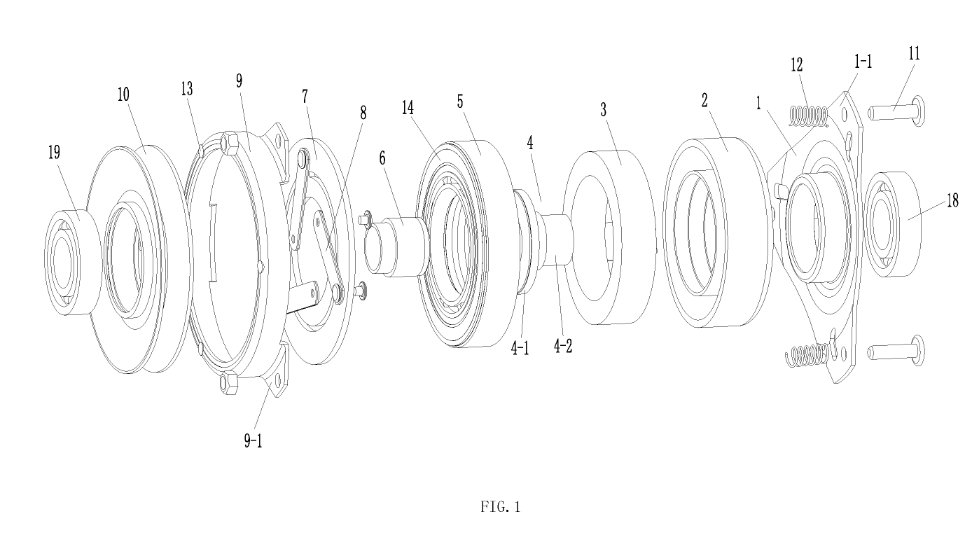

FIG. 2 is a cross-sectional view of the spring clutch

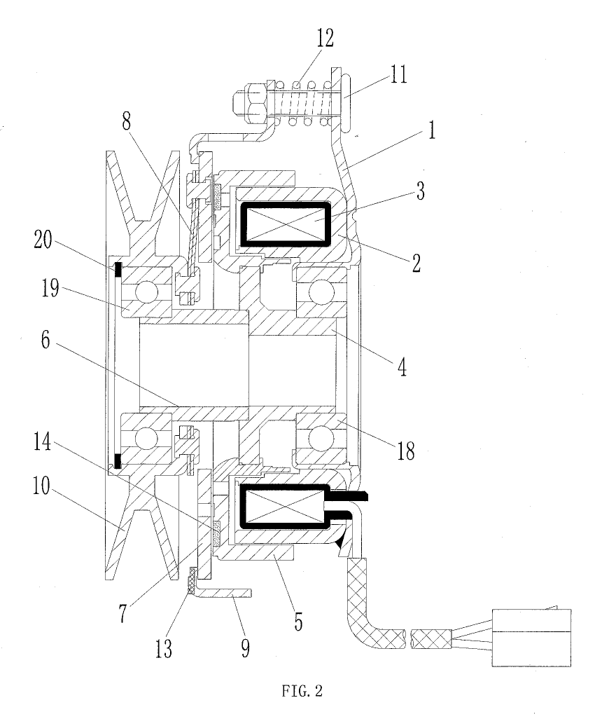

FIG. 3 is a structural representation of the thermal fuse in the encapsulated coil.

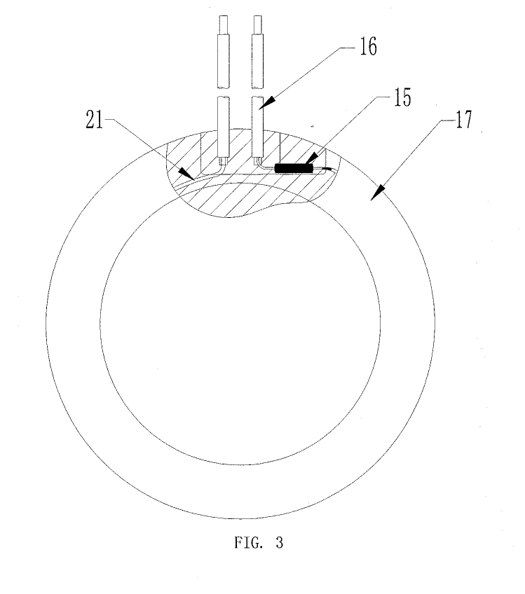

### DETAILED DESCRIPTION OF THE PREFERRED EMBODIMENTS

Referring now to the drawings wherein like reference numerals are used to identical components, the present invention comprises a coil assembly, a rotor assembly and a pulley assembly.

A spring clutch in accordance with the present invention the coil assembly comprises a coil housing 2, an encapsulated coil 3 and a shell 1. The encapsulated coil 3 is put in the coil housing 2. The coil housing 2 put in the shell 1. The shell 1 is triangular structure and the shell 1 has outside pieces 1-1.

In accordance with the present invention, the rotor assembly comprises a shaft 4, a rotor 5 and a sleeve 6. The shaft 4 is pressed into the inner hole of the rotor 5. The shaft 4 is inside of the rotor 5. The sleeve 6 is on the shaft 4. The shaft 4 is inside of the coil housing 2. The side of the rotor 5 facing to an armature 7 is the frictional area, the rotor 5 catch up with the armature 7 when the clutch in electricity. The surface of the rotor 5 facing to armature 7 has a friction ring 14 inside. The shaft 4 has a front part 4-1 and a back part 4-2, the rotor 5 is in the front part 4-1, the coil housing 2 is in the back part 4-2, the shaft 6 is connected with the front part 4-1, the shaft 6 is fixed in the inner bore of a front part of shaft 4.

In accordance with the present invention, the pulley assembly comprises an armature 7, a leaf spring 8, a brake plate 9 and a pulley 10. One side of the leaf spring 8 is pressed on the armature 7 and another side of the leaf spring 8 is pressed on the pulley 10. The brake plate 9 is outside of the armature 7 and the brake plate 9 covers and overlaps some area of the armature 7. The pulley 10 is on the shaft 6. The brake plate 9 has magnet pieces 13 inside. The brake plate 9 has extended pieces 9-1. The shell 1 is a triangle structure. The three outside pieces 1-1 all have bolts 11. The extended pieces 9-1 all have holes. The brake plate 9 is fixed on shell 1 by bolts 11 which through the outside pieces 1-1, spring 12 and extended pieces 9-1 with nuts. The gap between brake plate 9 and armature 7 can be adjusted by tightening the bolts 11 and spring 12 as thickness of the armature 7 will be reduced after using some time.

In accordance with the present invention, the encapsulated coil 3 has thermal fuse 15 inside. Both sides of the thermal fuse 15 are connected with coil wire 21. Guide line 16 is electrical connected with coil wire 21. Thermal fuse 15 and coil wire 21 are totally covered by nylon 17.

In accordance with the present invention, the shell 1 has a bearing 18. The pulley has another bearing 19. The bearing 18 is put on the shaft 4. The second bearing 19 is put on the shaft 6. The above of bearing 19 has a snap ring 20 to fix the bearing 19, the snap ring 20 makes the bearing 19 be easily replaced.

The working principle is as follow: the engine shaft fixed into the shaft 4 makes the rotor 5 running all the time when the engine is working. The encapsulated coil 3 brings magnetic force when clutch is connected with electricity, the armature 7 catches up with the rotor 5 by the magnetic force from the encapsulated coil 3 and leaves the brake plate 9 at the same time. The surface of the rotor 5 has a friction ring 14 that can enlarge the friction when the armature 7 catches up with the rotor 5 to make armature 7 and pulley 10 starting run well. The pulley 10 drives the lawnmower blade by a belt. When the clutch powers off, the armature 7 leaves the rotor 5 and backs to the position against to the brake plate 9 by the force of leaf spring 8. The brake plate 9 has magnet pieces 13 inside to enlarge the friction force to make the armature 7 and pulley 10 stop running. The encapsulated coil 3 electrical connected with thermal fuse 15 makes the thermal fuse 15 cut off when the temperature of encapsulated coil higher than the melting point of the thermal fuse 15 caused by fitting incorrect or slipping happened during working to protect lawnmower parts or avoid fire accident by cutting off electricity.

1. A spring clutch comprising a coil assembly, a rotor assembly and a pulley assembly; wherein the coil assembly comprises a coil housing, an encapsulated coil and a shell, the encapsulated coil is in the coil housing; the rotor assembly comprises a shaft, a rotor and a sleeve, the sleeve is in the shaft, the shaft is in the rotor, the shaft is in the coil housing; the pulley assembly comprises an armature, leaf springs, a brake plate and a pulley, one side of the leaf spring is pressed with the armature and another side is pressed with a pulley, the brake plate is outside of the armature and covered some area of the armature, the pulley is on the sleeve; the brake plate has magnet pieces inside and on the brake plate.

2. The clutch of claim 1, wherein the encapsulated coil has a thermal fuse inside and the thermal fuse is electrically connected with the encapsulated coil.

3. The clutch of claim 1, wherein the surface of the rotor facing armature has a friction ring.

4. The clutch of claim 1, wherein the shaft has a front part and a back part, the pulley and sleeve are both in the front part, the coil is in the back part.

5. The clutch of claim 1, wherein the shell has outside pieces, the brake plate has extended pieces, and with bolts and springs, the bolts go through outside pieces, springs and extended pieces then fix the brake plate on the shell.
